(19) United States
(12) Patent Application Publication
(10) Pub. No.: US 2026/0180267 A1
(43) Pub. Date: Jun. 25, 2026

(54) COAXIAL CONNECTOR

(71) Applicant: Japan Aviation Electronics Industry, Limited, Tokyo (JP)

(72) Inventor: Akira KIMURA, Tokyo (JP)

(73) Assignee: Japan Aviation Electronics Industry, Limited, Tokyo (JP)

(21) Appl. No.: 19/366,674

(22) Filed: Oct. 23, 2025

(30) Foreign Application Priority Data
Dec. 20, 2024 (JP) 2024-225597

(51) Int. Cl. H01R 24/50; H01R 103/00

(52) U.S. Cl. CPC H01R 24/50; H01R 2103/00

(57) ABSTRACT

A coaxial connector has a shell and a nut component. The shell has a flange and a projecting portion projecting rearward from the flange. The projecting portion is formed with an upper passing hole. The nut component has a fixable portion formed with a screw hole, a movable portion formed with a lower passing hole and a coupling portion coupling the fixable portion and the movable portion together. The nut component can be attached to the shell by screwing a screw into the screw hole through the lower passing hole, a passing hole of a board and the upper passing hole. The coupling portion has an upper connection portion and a lower connection portion. The lower connection portion is located forward of the upper connection portion. The center of the screw hole is located forward of the upper connection portion.

### CROSS REFERENCE TO RELATED APPLICATIONS

This application is based on and claims priority under 35 U.S.C. §119 to Japanese Patent Application No. JP 2024-225597 filed December 20, 2024, the content of which is incorporated herein in its entirety by reference.

### BACKGROUND OF THE INVENTION

This invention relates to a coaxial connector configured to be connected to a board.

For example, this type of coaxial connector is disclosed in JP6853655B (Patent Document 1), the content of which is incorporated herein by reference.

Referring to FIGS. 24 and 25, Patent Document 1 discloses a coaxial connector 90 configured to be connected to a board 95. The board 95 comprises a signal pattern (signal line) 96, a first ground layer 97 and a plating layer 98. The plating layer 98 is electrically connected with the first ground layer 97. More specifically, the plating layer 98 is formed on an area including an end surface of the first ground layer 97 and is located right under the signal line 96. The coaxial connector 90 comprises a center conductor (contact) 92 and an outer conductor (shell) 93. The coaxial connector 90 is configured to be connected to the board 95 with two screws 91. When the coaxial connector 90 is connected to the board 95, the shell 93 is brought into contact with the plating layer 98 to be grounded to the first ground layer 97. According to Patent Document 1, the aforementioned structure can improve reflection characteristics of signals transmitted between the board 95 and the coaxial connector 90.

When the coaxial connector 90 of Patent Document 1 is connected to the board 95, the plating layer 98 of the board 95 might not be stably in contact with the shell 93 of the coaxial connector 90. Thus, the electric connection between the shell 93 and the first ground layer 97 might be unreliable.

### SUMMARY OF THE INVENTION

It is therefore an object of the present invention to provide a coaxial connector which comprises a shell configured to be stably connected to a ground layer of a board.

An aspect of the present invention provides a coaxial connector which is configured to be attached to a rear end of a coaxial cable in a front-rear direction and is configured to be connected to a board. The board has an upper surface and a lower surface in an up-down direction perpendicular to the front-rear direction and is formed with two passing holes each passing through the board in the up-down direction. The upper surface of the board is formed with a signal line. The signal line is located between the two passing holes in a lateral direction perpendicular to both the front-rear direction and the up-down direction. The lower surface of the board is formed with a ground layer. The coaxial connector comprises a shell, a contact, a nut component made of metal and two screws. The shell has a flange and two projecting portions. Each of the projecting portions projects rearward from the flange. Each of the projecting portions is formed with an upper passing hole. Each of the upper passing holes passes through the projecting portion in the up-down direction. The nut component has a fixable portion, a movable portion and two coupling portions. The fixable portion is located at an upper side of the nut component. The movable portion is located at a lower side of the nut component. Each of the coupling portions couples the fixable portion and the movable portion together. The fixable portion is formed with two screw holes which correspond to the coupling portions, respectively. The movable portion is formed with two lower passing holes. Each of the lower passing holes passes through the movable portion in the up-down direction. The nut component is configured to be attached to the shell by arranging the fixable portion above the projecting portions, arranging the movable portion below the projecting portions, inserting the board between the projecting portions and the movable portion, and screwing the two screws into the screw holes of the fixable portion, respectively, through the lower passing holes of the movable portion, the passing holes of the board and the upper passing holes of the projecting portions. Each of the coupling portions of the nut component has an upper connection portion and a lower connection portion. Each of the upper connection portions is located at a boundary between the coupling portion and the fixable portion. Each of the lower connection portions is located at a boundary between the coupling portion and the movable portion. In each of the coupling portions, the lower connection portion is located forward of the upper connection portion. Each of the screw holes has a center which is located forward of the upper connection portion of a corresponding one of the coupling portions.

Another aspect of the present invention provides a coaxial connector comprising a shell, a contact, a nut component made of metal and two screws. The shell has a flange and two projecting portions. Each of the projecting portions projects rearward from the flange. Each of the projecting portions is formed with an upper passing hole. Each of the upper passing holes passes through the projecting portion in the up-down direction. The nut component has a fixable portion, a movable portion and two coupling portions. The fixable portion is located at an upper side of the nut component. The movable portion is located at a lower side of the nut component. Each of the coupling portions couples the fixable portion and the movable portion together. The fixable portion is formed with two screw holes which correspond to the coupling portions, respectively. The movable portion is formed with two lower passing holes. Each of the lower passing holes passes through the movable portion in the up-down direction. The nut component is configured to be attached to the shell by arranging the fixable portion above the projecting portions, arranging the movable portion below the projecting portions and screwing the two screws into the screw holes of the fixable portion, respectively, through the lower passing holes of the movable portion and the upper passing holes of the projecting portions. Each of the coupling portions of the nut component has an upper connection portion and a lower connection portion. Each of the upper connection portions is located at a boundary between the coupling portion and the fixable portion. Each of the lower connection portions is located at a boundary between the coupling portion and the movable portion. In each of the coupling portions, the lower connection portion is located forward of the upper connection portion. Each of the screw holes has a center which is located forward of the upper connection portion of a corresponding one of the coupling portions.

According to the coaxial connector of an aspect of the present invention, the nut component attached to the shell is connected to the shell at the fixable portion. Moreover, the lower connection portions of the nut component are located forward of the upper connection portions, and the centers of the screw holes are located forward of the upper connection portions. According to this positional relation, the movable portion is moved upward and forward when the nut component is attached to the shell with the screws together with the board. The movable portion, which is moved upward, is pressed against the ground layer of the board. The movable portion, which is moved forward, can be pressed against the flange of the shell. As described above, the shell of an aspect of the present invention can be reliably grounded to the ground layer of the board through the nut component. Thus, an aspect of the present invention provides a coaxial connector which comprises a shell configured to be stably connected to a ground layer of a board.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is an exploded, perspective view showing a connector assembly according to an embodiment of the present invention, wherein an outline of a coaxial cable configured to be connected to a coaxial connector of the connector assembly is illustrated with dashed line, and a part of a board of the connector assembly enclosed by dashed line is enlarged and illustrated.

FIG. 2 is an exploded, perspective view showing the coaxial connector of the connector assembly of FIG. 1, wherein a contact received in an insulation member is enlarged and illustrated.

FIG. 3 is a perspective view showing a connector body formed of a shell, the contact and the insulation member of the coaxial connector of FIG. 2, wherein hidden outlines of upper passing holes of the connector body and outlines of shafts of screws are illustrated with dashed line.

FIG. 4 is a perspective view showing a nut component of the coaxial connector of FIG. 2.

FIG. 5 is another perspective view showing the nut component of FIG. 4.

FIG. 6 is a front view showing the nut component of FIG. 4, wherein outlines of hidden screw holes, outlines of hidden lower passing holes and outlines of the shafts are illustrated with dashed line.

FIG. 7 is a side view showing the nut component of FIG. 4, wherein a female thread of a hidden screw hole is schematically illustrated with dashed line, and a position of the center of the screw hole is illustrated with chain dotted line.

FIG. 8 is a perspective view showing the connector body of FIG. 3 together with the nut component, the screws and the board, wherein the board is separated from the connector body.

FIG. 9 is a perspective view showing the connector body, the nut component, the screws and the board of FIG. 8, wherein the board is inserted between projecting portions of the connector board and a movable portion of the nut component.

FIG. 10 is a perspective view showing the coaxial connector together with the board of FIG. 9, wherein the coaxial connector is formed of the connector body, the nut component and the screws of FIG. 9 and is under a connected state where it is connected to the board.

FIG. 11 is another perspective view showing the coaxial connector and the board of FIG. 10, wherein an outline of the coaxial cable is illustrated with dashed line.

FIG. 12 is a side view showing the coaxial connector and the board of FIG. 10, wherein outlines of a hidden lower passing hole, a hidden passing hole, a hidden upper passing hole and a hidden screw hole are illustrated with dashed line.

FIG. 13 is a bottom view showing the coaxial connector and the board of FIG. 10.

FIG. 14 is another side view showing the nut component of FIG. 7, wherein the nut component is under the connected state, and an outline of the movable portion of the nut component of FIG. 7 is illustrated with dashed line.

FIG. 15 is a perspective view showing a modification of the board of FIG. 1.

FIG. 16 is a side view showing a first modification of the nut component of FIG. 4, wherein a position of the center of a screw hole is illustrated with chain dotted line.

FIG. 17 is a side view showing a second modification of the nut component of FIG. 4, wherein a position of the center of a screw hole is illustrated with chain dotted line.

FIG. 18 is a perspective view showing a third modification of the nut component of FIG. 4.

FIG. 19 is a perspective view showing a fourth modification of the nut component of FIG. 4.

FIG. 20 is a perspective view showing a fifth modification of the nut component of FIG. 4.

FIG. 21 is a side view showing the nut component of FIG. 20, wherein outlines of a hidden screw hole and a hidden lower passing hole are illustrated with dashed line, and a position of the center of the screw hole is illustrated with chain dotted line.

FIG. 22 is a perspective view showing a sixth modification of the nut component of FIG. 4.

FIG. 23 is a side view showing the nut component of FIG. 22, wherein outlines of a hidden screw hole and a hidden lower passing hole are illustrated with dashed line, and a position of the center of the screw hole is illustrated with chain dotted line.

FIG. 24 is a perspective view showing a coaxial connector and a board of Patent Document 1.

FIG. 25 is a cross-sectional view partially showing the coaxial connector and the board of FIG. 24.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

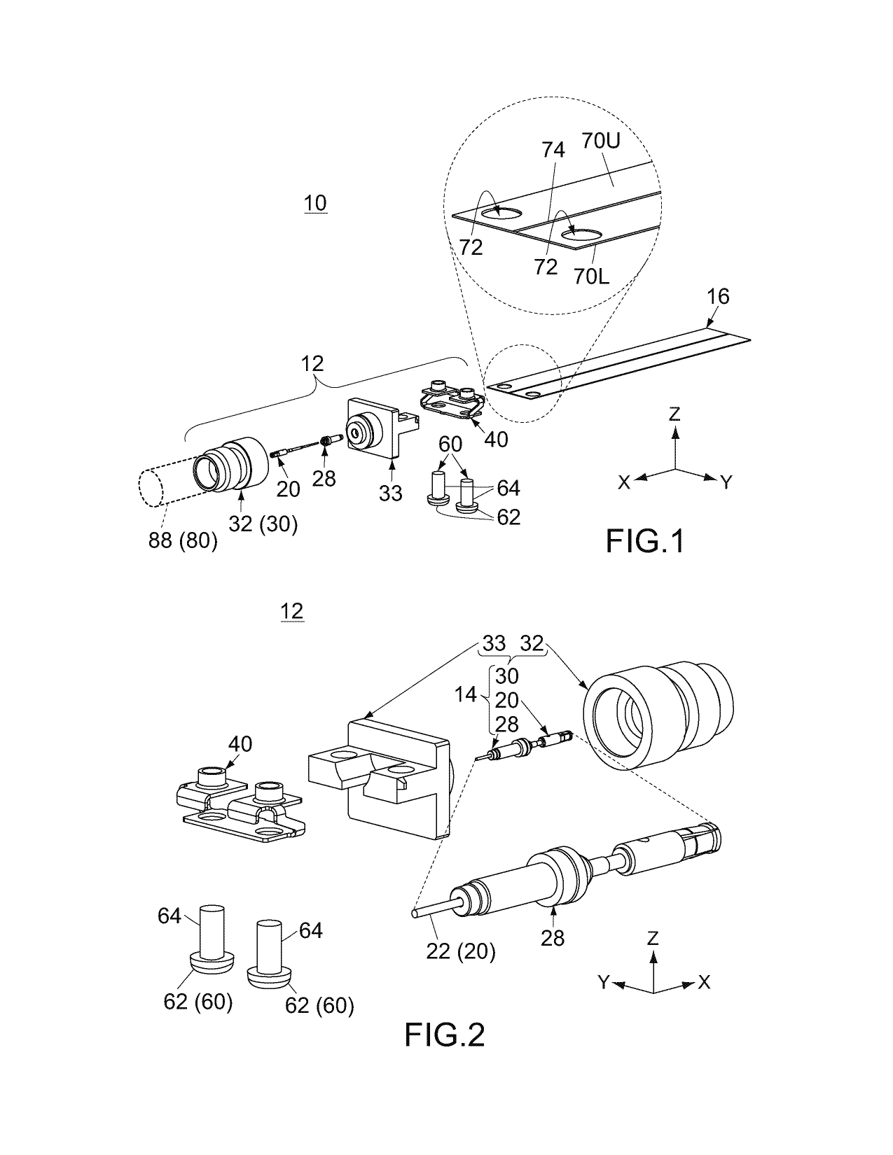

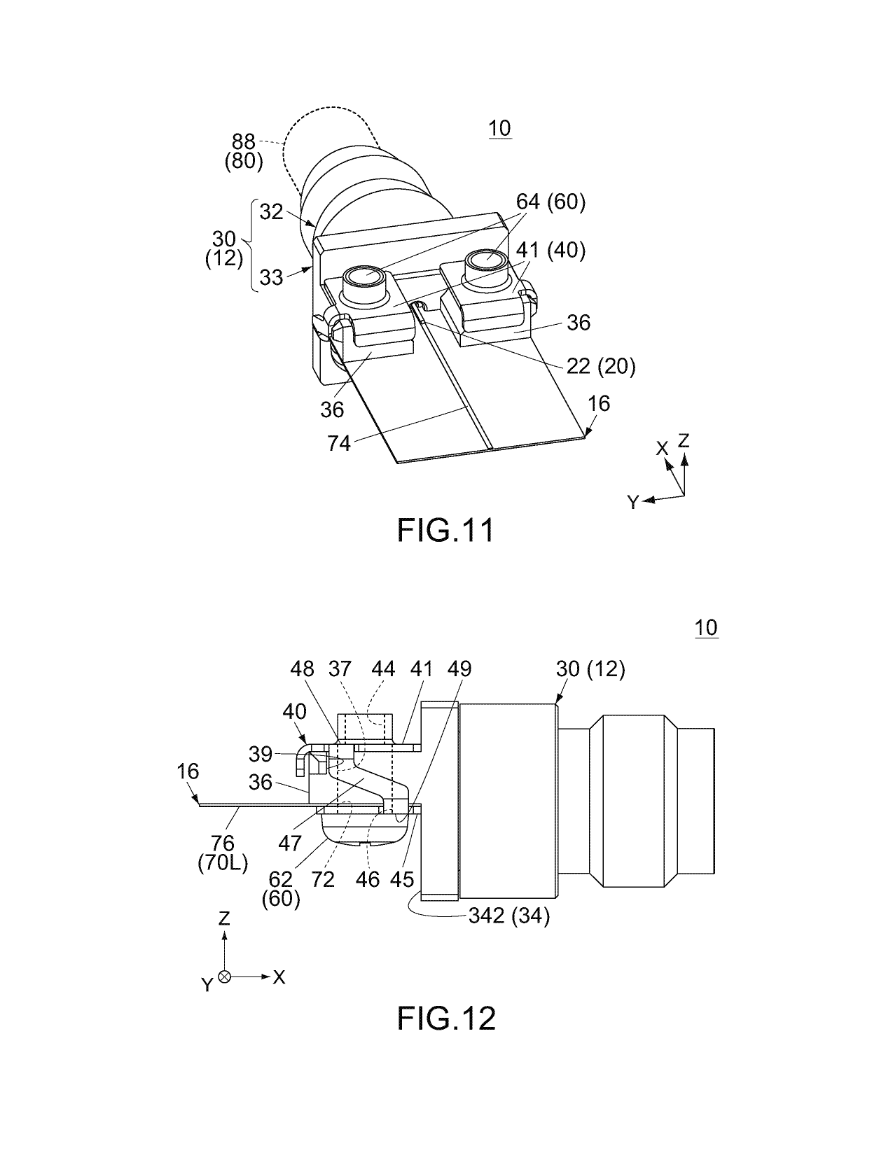

Referring to FIG. 1 together with FIG. 11, a connector assembly 10 according to an embodiment of the present invention comprises a coaxial connector 12 and a board 16. The coaxial connector 12 of the present embodiment is a so-called sub miniature type A (SMA) connector. The coaxial connector 12 is configured to be attached to a rear end of a coaxial cable 80 in a front-rear direction and is configured to be connected to the board 16. In detail, the coaxial connector 12 is configured to be connected to a front end part of the board 16 which extends along a horizontal plane. The board 16 of the present embodiment is a flexible circuit board and is easily bendable. However, the present invention is not limited to the present embodiment but is applicable to various coaxial connectors 12. For example, the board 16 may be a rigid circuit board.

In the present embodiment, the horizontal plane is the XY-plane, and the front-rear direction is the X-direction. In the present embodiment, “forward” means the positive X direction, and “rearward” means the negative X direction. The words such as the horizontal plane and the front-rear direction do not indicate the absolute positional relation relative to the ground but merely indicate a relative positional relation under a definition in which a plane along which the unbent board 16 extends is the horizontal plane and the coaxial connector 12 is located forward of this board 16.

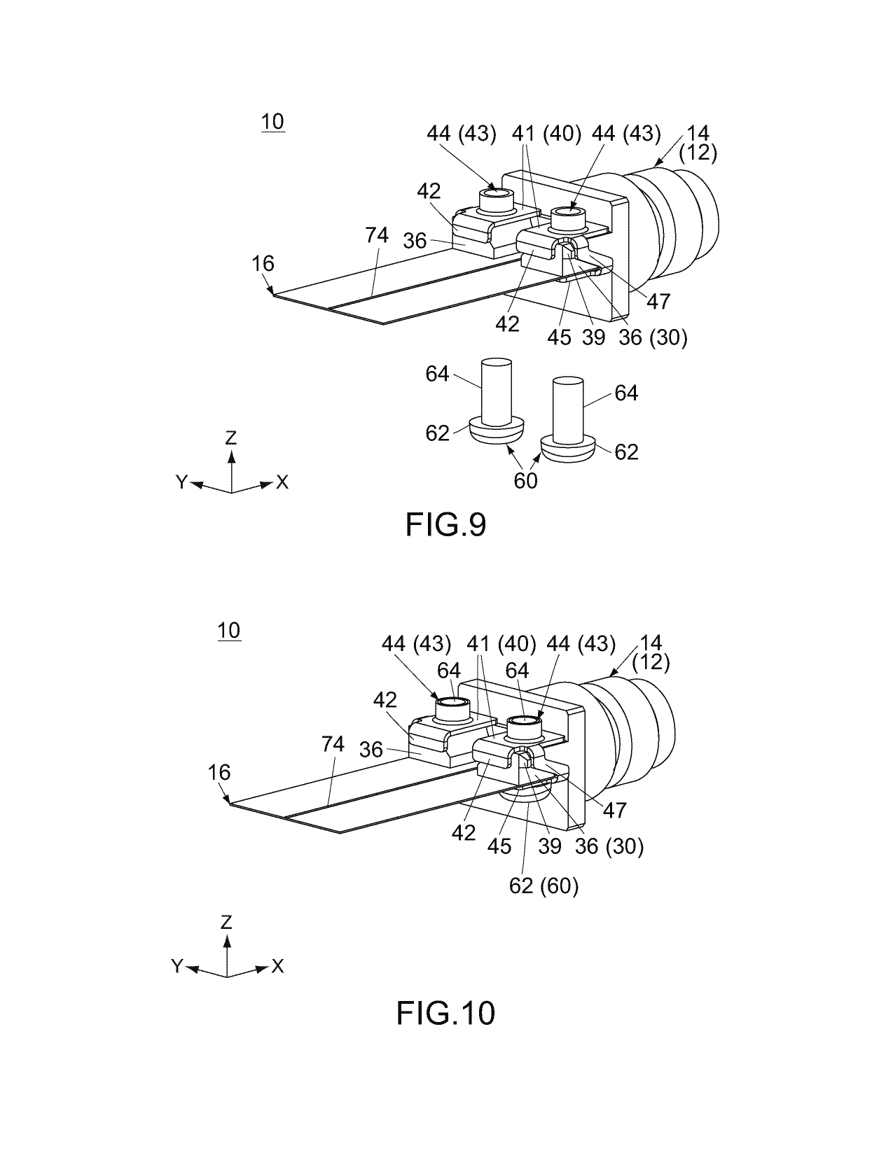

Referring to FIGS. 8 to 10, the coaxial connector 12 is configured to be fixed and connected to the board 16 via screwing. The coaxial connector 12 of FIG. 8 is under a pre-connected state where the coaxial connector 12 is not yet connected to the board 16. The coaxial connector 12 of FIG. 9 is under a half-connected state where the coaxial connector 12 is halfway to be connected to the board 16. The coaxial connector 12 of FIG. 10 is under a connected state where the coaxial connector 12 is connected to the board 16.

Hereafter, explanation will be made about the coaxial cable 80 (see FIG. 1) and the board 16 of the present embodiment.

Referring to FIG. 1, the coaxial cable 80 illustrated with dashed line is a typical coaxial cable and comprises a center conductor (not shown) made of conductor, an inner insulator (not shown) made of insulator and covering the center conductor, an outer conductor (not shown) made of conductor and covering the inner insulator and a sheath 88 made of insulator and covering the outer conductor. The number of the center conductor of the present embodiment is one. The structure of the coaxial cable 80 is not specifically limited, provided that the number of the center conductor is one. For example, the outer conductor may be a braid formed of fine metal wires or may be made of metal foil. The coaxial cable 80 may be attached to a front end of the coaxial connector 12 via a mating connector (not shown) attached to the coaxial cable 80.

The board 16 has an upper surface 70U and a lower surface 70L in an up-down direction perpendicular to the front-rear direction. The upper surface 70U and the lower surface 70L are located at an upper end and a lower end of the board 16, respectively. The up-down direction of the present embodiment is the Z-direction. In the present embodiment, “upward” means the positive Z-direction, and “downward” means the negative Z-direction.

The board 16 is formed with two passing holes 72 each passing through the board 16 in the up-down direction. Each of the passing holes 72 has a circular shape in the horizontal plane. The thus-formed passing holes 72 are used when the coaxial connector 12 is fixed to the board 16 via screwing. The two passing holes 72 are apart from each other in a lateral direction perpendicular to both the front-rear direction and the up-down direction and are located at positions same as each other in the front-rear direction. The lateral direction of the present embodiment is the Y-direction.

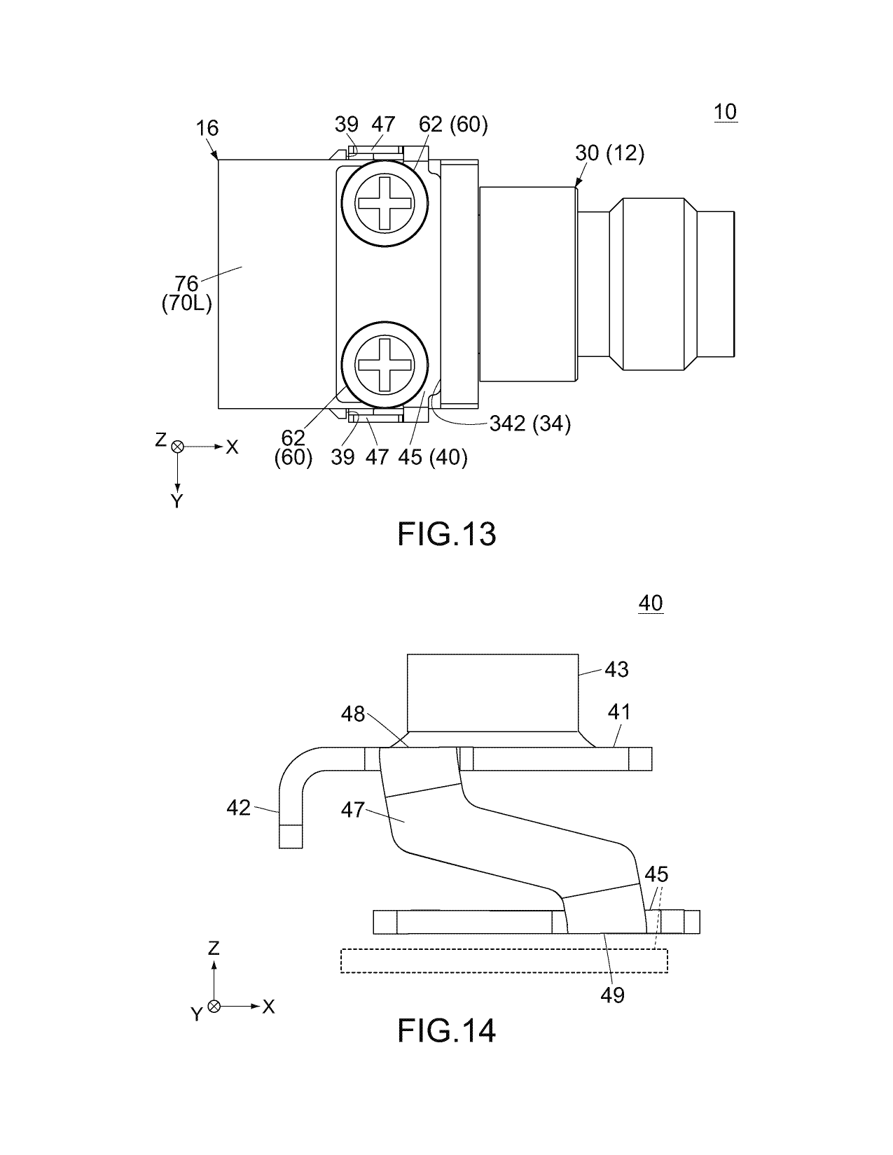

The upper surface 70U of the board 16 is formed with a signal line 74 which is a conductive pattern. The signal line 74 extends in the front-rear direction and is located between the two passing holes 72 in the lateral direction. Referring to FIG. 13, the lower surface 70L of the board 16 is formed with a ground layer 76 which is a conductive pattern. The ground layer 76 of the present embodiment covers the whole lower surface 70L. Thus, the board 16 is formed with a so-called microstrip line.

Referring to FIG. 1, the signal line 74 is connected to an antenna which is formed on an unillustrated rear end part of the board 16, for example. The coaxial connector 12 of this instance transmits signals to the antenna through the signal line 74 under the connected state. The thus-transmitted signals are sent out from the antenna. The signals received by the antenna are transmitted to the coaxial connector 12 through the signal line 74. The connector assembly 10 of the present embodiment can be used as described above, for example. However, the purpose of the connector assembly 10 of the present invention is not specifically limited.

The board 16 of the present embodiment has the aforementioned structure. However, the structure of the board 16 can be modified in accordance with the purpose of the connector assembly 10. For example, the shape of each of the passing holes 72 is not specifically limited. The passing holes 72 may be located at positions different from each other to some extent in the front-rear direction. Moreover, the ground layer 76 may be partially formed on the lower surface 70L.

Referring to FIG. 2, the coaxial connector 12 of the present embodiment comprises a connector body 14, a nut component 40 made of metal and two screws 60. The coaxial connector 12 of the present embodiment comprises only the aforementioned members. However, the present invention is not limited thereto. For example, the coaxial connector 12 may further comprise another member in addition to the aforementioned members.

Referring to FIG. 1 together with FIG. 11, the coaxial connector 12 is configured to be fixed and connected to the board 16 via screwing by using the screws 60 which correspond to the passing holes 72 of the board 16, respectively. Each of the screws 60 of the present embodiment is a typical screw made of metal and has a head 62 and a shaft 64. Each of the shafts 64 is formed with a male thread (not shown). Each of the heads 62 has a diameter larger than a diameter of the shaft 64 and a diameter of the corresponding passing hole 72. The diameter of each of the shafts 64 is smaller than the diameter of the corresponding passing hole 72. Each of the screws 60 of the present embodiment has the aforementioned structure. However, the present invention is not limited thereto. For example, each of the screws 60 may be made of insulator.

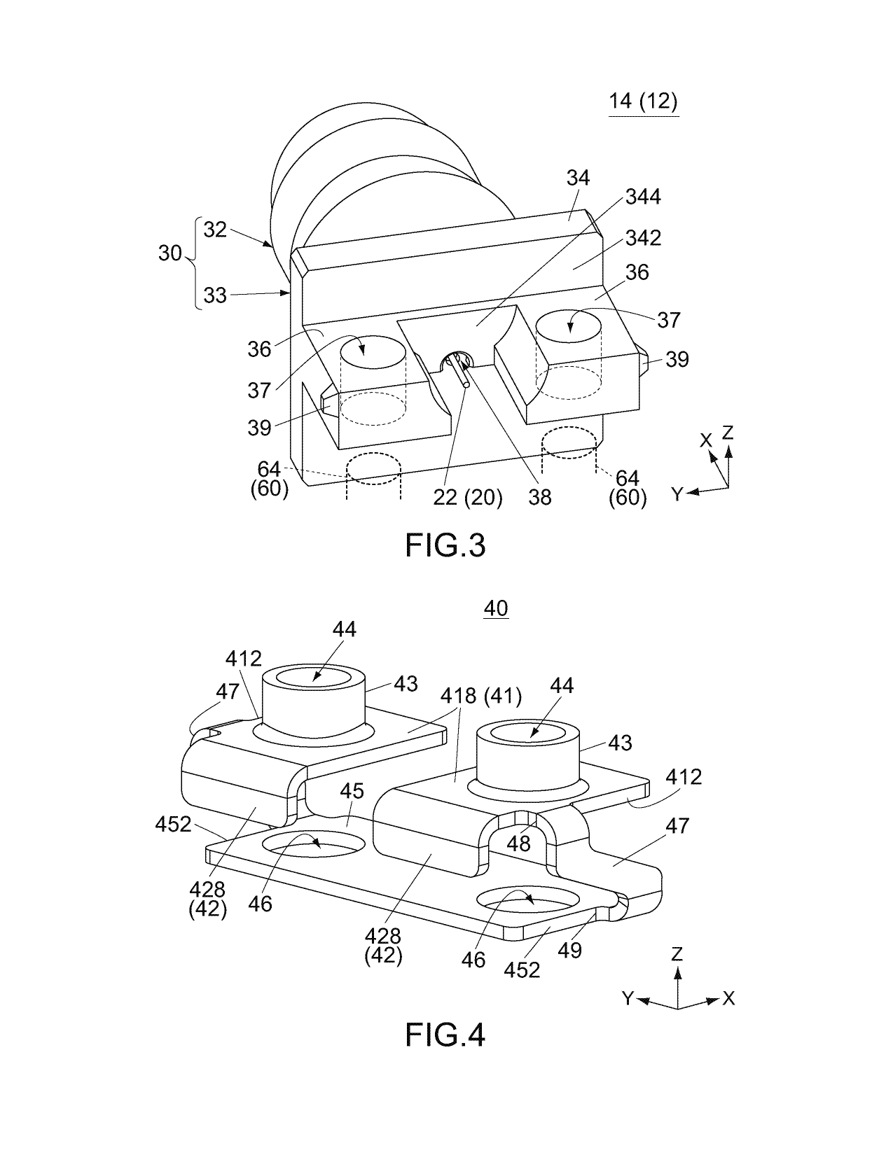

Hereafter, explanation will be made about the connector body 14 (see FIG. 3) of the present embodiment.

Referring to FIG. 2 together with FIG. 3, the connector body 14 of the present embodiment comprises a contact 20 made of metal, an insulation member 28 made of insulator such as resin and a shell 30 made of metal. Thus, the coaxial connector 12 of the present embodiment comprises the contact 20, the insulation member 28 and the shell 30 in addition to the nut component 40 and the screws 60. The connector body 14 of the present embodiment comprises only the aforementioned members. However, the present invention is not limited thereto. For example, the connector body 14 may further comprise another member in addition to the aforementioned members.

The contact 20 of the present embodiment extends along the front-rear direction and has a contact portion 22. The contact portion 22 is located at a rear end of the contact 20 in the front-rear direction. The contact 20 is partially received in the insulation member 28. The contact portion 22 projects rearward from the insulation member 28. Referring to FIG. 11, the contact 20 is connected to the center conductor (not shown) of the coaxial cable 80 when the coaxial connector 12 is attached to the coaxial cable 80. The contact 20 and the center conductor connected to each other transmit signals therebetween.

Referring to FIG. 2 together with FIG. 3, the shell 30 of the present embodiment comprises a front conductive member 32 and a rear conductive member 33. The front conductive member 32 is combined with the rear conductive member 33 after the contact 20 received in the insulation member 28 is arranged in the rear conductive member 33. The front conductive member 32 is located forward of the rear conductive member 33 and is in contact with the rear conductive member 33. The shell 30 of the present embodiment consists of the aforementioned two members. However, the present invention is not limited thereto. For example, each of the front conductive member 32 and the rear conductive member 33 may be a part of an integrally formed single member.

Referring to FIG. 11, the shell 30 is connected to the outer conductor (not shown) of the coaxial cable 80 when the coaxial connector 12 is attached to the coaxial cable 80. More specifically, the front conductive member 32 of the shell 30 is connected to the outer conductor, and thereby the whole of the shell 30 is electrically connected with the outer conductor. The shell 30 and the outer conductor which are connected to each other have the same ground voltage.

Referring to FIG. 2 together with FIG. 3, the contact 20, the insulation member 28 and the shell 30 are combined together as described above to form the connector body 14. In the thus-fabricated connector body 14, the insulation member 28 insulates the contact 20 and the shell 30 from each other.

Hereafter, further specific explanation will be made about the shell 30 of the fabricated connector body 14.

As shown in FIG. 3, the shell 30 has a flange 34 and two projecting portions 36. Each of the flange 34 and the projecting portions 36 of the present embodiment is provided on the rear conductive member 33.

The flange 34 of the present embodiment has an end surface 342 and a protruding portion 344. The end surface 342 is a flat surface in parallel to a vertical plane (YZ-plane) perpendicular to the front-rear direction. The protruding portion 344 is located at the middle of the flange 34 in each of the up-down direction and the lateral direction and protrudes rearward from the end surface 342. The protruding portion 344 has a rear surface which is a flat surface in parallel to the vertical plane.

The protruding portion 344 of the present embodiment is formed with a center hole 38. The center hole 38 is a hole which has a half circular shape in the vertical plane (YZ-plane). The center hole 38 is located at the middle of the protruding portion 344 in the lateral direction and is located at a lower end of the protruding portion 344 in the up-down direction. The center hole 38 opens rearward and downward.

The flange 34 of the present embodiment has the aforementioned structure. However, the present invention is not limited thereto. For example, the protruding portion 344 may be provided as necessary.

The two projecting portions 36 of the present embodiment are apart from each other in the lateral direction. The protruding portion 344 couples front end parts of the two projecting portions 36 together in the lateral direction. Thus, the center hole 38 is located between the two projecting portions 36 in the lateral direction. Each of the projecting portions 36 projects rearward from the flange 34. In detail, each of the projecting portions 36 projects rearward from the end surface 342 beyond the rear surface of the protruding portion 344. The two projecting portions 36 have a mirror-symmetric shape with respect to a perpendicular plane (XZ-plane) perpendicular to the lateral direction. Thus, the two projecting portions 36 are located at positions same as each other in the up-down direction.

Each of the projecting portions 36 is formed with an upper passing hole 37. Each of the upper passing holes 37 passes through the projecting portion 36 in the up-down direction. The upper passing holes 37 are located at positions which correspond to the passing holes 72 of the board 16 (see FIG. 1) in the horizontal plane, respectively. Thus, the two upper passing holes 37 are apart from each other in the lateral direction and are located at positions same as each other in the front-rear direction. The two upper passing holes 37 are located at positions same as each other also in the up-down direction. Each of the upper passing holes 37 has a circular shape in the horizontal plane. Each of the upper passing holes 37 has a diameter which is larger than the diameter of the shaft 64 of the screw 60. Each of the shafts 64 can pass through the upper passing hole 37 with no contact with an inner wall surface of the upper passing hole 37.

Each of the projecting portions 36 of the present embodiment is provided with a regulation portion 39. Thus, the shell 30 of the present embodiment is provided with the two regulation portions 39. Each of the regulation portions 39 projects outward in the lateral direction from the projecting portion 36.

Each of the projecting portions 36 of the present embodiment has the aforementioned structure. However, the present invention is not limited thereto. For example, the two projecting portions 36 may have a mirror-unsymmetric shape with respect to the perpendicular plane (XZ-plane). Each of the upper passing holes 37 may be formed with a female thread into which the shaft 64 of the screw 60 can be screwed.

The connector body 14 has the aforementioned structure, and the contact portion 22 of the contact 20 is located between the two projecting portions 36 in the lateral direction. In detail, the contact portion 22 is located at the center of the center hole 38 in the vertical plane (YZ-plane). The contact portion 22 extends rearward beyond the end surface 342. Thus, the contact portion 22 is located rearward of the end surface 342.

Referring to FIG. 11, the contact portion 22 of the contact 20 is brought into contact with the signal line 74 of the board 16 under the connected state, and thereby the signals are transmitted between the contact portion 22 and the signal line 74. The lower parts of the two projecting portions 36 should be apart from each other in the lateral direction so that the contact portion 22 and the signal line 74 are brought into contact with each other. The upper parts of the two projecting portions 36 may be connected to each other over all the projecting portions 36. However, this structure makes it difficult to form the rear conductive member 33 by machining. The present embodiment is preferable from a viewpoint of easy formation of the rear conductive member 33.

Hereafter, explanation will be made about the nut component 40 of the present embodiment.

Referring to FIG. 4, the nut component 40 of the present embodiment is formed by applying processes such as bending and burring to a single metal plate. In other words, the nut component 40 of the present embodiment is a single metal plate with bends. However, the present invention is not limited thereto. For example, the nut component 40 may be formed of a plurality of metal members joined together.

As shown in FIGS. 4 to 6, the nut component 40 of the present embodiment has a fixable portion 41, a downward extending portion 42, a movable portion 45 and two coupling portions 47. Each of the fixable portion 41, the downward extending portion 42, the movable portion 45 and the coupling portions 47 of the present embodiment is a part of the single nut component 40. The nut component 40 of the present embodiment has the aforementioned portions. However, the present invention is not limited thereto. For example, the downward extending portion 42 may be provided as necessary. The nut component 40 may further have another portion in addition to the aforementioned portions. The fixable portion 41, the downward extending portion 42, the movable portion 45 and the coupling portions 47 may be formed separately from each other and then may be joined together.

The fixable portion 41 of the present embodiment is an upper part of the nut component 40. In other words, the fixable portion 41 is located at an upper side of the nut component 40. The downward extending portion 42 of the present embodiment extends downward from a rear end of the fixable portion 41. Thus, the downward extending portion 42 is located rearward of the fixable portion 41.

The fixable portion 41 of the present embodiment includes two fixable sections 418 which correspond to the coupling portions 47, respectively. The downward extending portion 42 of the present embodiment includes two downward extending sections 428 which correspond to the fixable sections 418, respectively. In other words, the nut component 40 has the two fixable sections 418 and the two downward extending sections 428. The two fixable sections 418 are apart from each other in the lateral direction. Each of the downward extending sections 428 extends downward from a rear end of the corresponding fixable section 418. Thus, the two downward extending sections 428 are apart from each other in the lateral direction.

The fixable portion 41 has two upper edges 412. Each of the upper edges 412 of the present embodiment is located at an outer edge of the fixable portion 41 in the lateral direction. In detail, the two fixable sections 418 have four edge surfaces in the lateral direction. The two upper edges 412 are two of these four edge surfaces that are most apart from each other in the lateral direction. More specifically, each of the upper edges 412 is an edge surface of the fixable portion 41 which faces outward of the fixable portion 41 in the lateral direction and extends along the front-rear direction.

Each of the fixable sections 418 has a cylindrical portion 43. Thus, the fixable portion 41 has the two cylindrical portions 43 which correspond to the coupling portions 47, respectively. Each of the cylindrical portions 43 has a cylindrical shape and projects upward from an upper surface of a flat-plate portion which is a part of the fixable portion 41 and has a flat-plate shape. Each of the cylindrical portions 43 is formed with a screw hole 44 located therein. Thus, the fixable portion 41 is formed with the two screw holes 44 which correspond to the coupling portions 47, respectively.

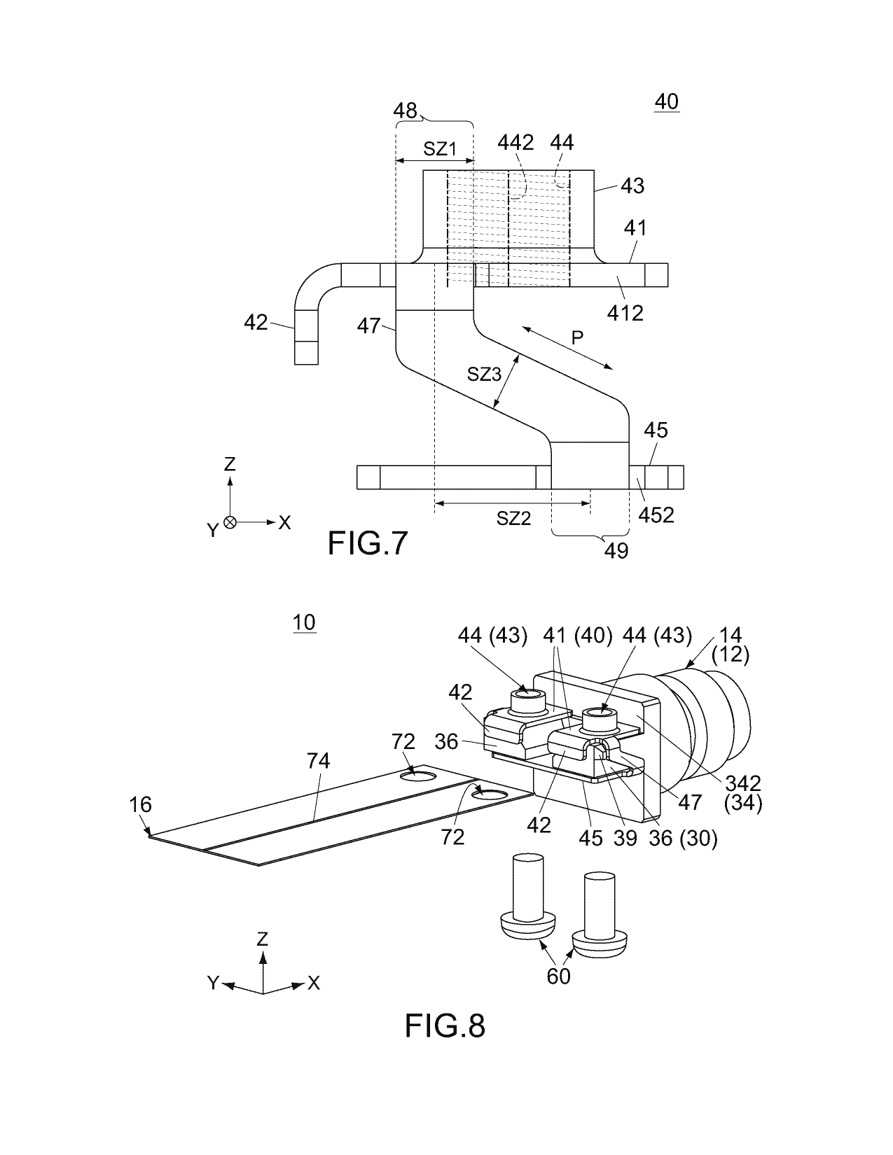

Referring to FIG. 6 together with FIG. 7, each of the screw holes 44 is formed with a female thread (not shown in FIG. 6) into which the shaft 64 of the screw 60 can be screwed. The screw holes 44 are provided at positions which correspond to the passing holes 72 (see FIG. 1) of the board 16 (see FIG. 1) in the horizontal plane, respectively. The thus-provided two screw holes 44 are apart from each other in the lateral direction and are located at positions same as each other in the front-rear direction. The two screw holes 44 are located at positions same as each other also in the up-down direction. Each of the screw holes 44 of the present embodiment passes through the fixable portion 41 in the up-down direction. In other words, each of the screw holes 44 opens upward and downward. However, the present invention is not limited thereto. For example, each of the screw holes 44 may open only downward.

Referring to FIGS. 4 to 6, the movable portion 45 of the present embodiment is a lower part of the nut component 40. In other words, the movable portion 45 is located at a lower side of the nut component 40. The movable portion 45 has a rectangular flat-plate shape in parallel to the horizontal plane and has two lower edges 452. Each of the lower edges 452 is located at an outer edge of the movable portion 45 in the lateral direction. More specifically, each of the lower edges 452 is an edge surface of the movable portion 45 which faces outward of the movable portion 45 in the lateral direction and extends along the front-rear direction.

The movable portion 45 is formed with two lower passing holes 46. Each of the lower passing holes 46 passes through the movable portion 45 in the up-down direction. The lower passing holes 46 are provided at positions which correspond to the passing holes 72 (see FIG. 1) of the board 16 (see FIG. 1) in the horizontal plane, respectively. Thus, the two lower passing holes 46 are apart from each other in the lateral direction and are located at positions same as each other in the front-rear direction. Each of the lower passing holes 46 has a circular shape in the horizontal plane. Each of the lower passing holes 46 has a diameter which is larger than the diameter of the shaft 64 of the screw 60. Each of the shafts 64 can pass through the lower passing hole 46 with no contact with an inner wall surface of the lower passing hole 46.

Referring to FIG. 6 together with FIG. 7, the coupling portions 47 of the present embodiment are located at opposite sides of the nut component 40 in the lateral direction, respectively. Each of the coupling portions 47 couples the fixable portion 41 and the movable portion 45 together. In detail, each of the coupling portions 47 has an upper connection portion 48 and a lower connection portion 49. Each of the upper connection portions 48 is located at a boundary between the coupling portion 47 and the fixable portion 41. Each of the lower connection portions 49 is located at a boundary between the coupling portion 47 and the movable portion 45. Each of the coupling portions 47 continuously extends between the upper connection portion 48 and the lower connection portion 49 while meandering. Each of the coupling portions 47 of the present embodiment couples one of the upper edges 412 and one of the lower edges 452 together.

The nut component 40 of the present embodiment has the aforementioned structure. However, the present invention is not limited thereto. As described below, the structure of the nut component 40 can be modified as necessary.

The fixable portion 41 of the present embodiment is divided into two portions, or the fixable sections 418, in the lateral direction, while the movable portion 45 of the present embodiment is a single plate formed with the two lower passing holes 46. In particular, the movable portion 45 of the present embodiment is a single flat plate. However, the present invention is not limited thereto. For example, the fixable portion 41 may be a single portion which continuously extends with no gap in the lateral direction. In this instance, the downward extending portion 42 may be a single portion which continuously extends with no gap in the lateral direction. However, as can be seen from FIG. 4, if the two fixable sections 418 are connected to each other in the lateral direction, the nut component 40 cannot be formed of a single metal plate. The present embodiment is preferable from a viewpoint of easy manufacture of the nut component 40.

Each of the screw holes 44 of the present embodiment is formed in the flat-plate portion of a flat-plate shape and the cylindrical portion 43 of the fixable portion 41. However, the present invention is not limited thereto. For example, the cylindrical portions 43 do not need to be provided on the fixable portion 41 of an instance in which the flat-plate portion of the fixable portion 41 has a sufficient large size in the up-down direction. In this instance, the fixable portion 41 may be two flat plates which are formed with the two screw holes 44, respectively. Thus, each of the screw holes 44 may be formed only in the flat-plate portion of the fixable portion 41.

Referring to FIGS. 8 to 10, the nut component 40 is attachable to the connector body 14 as described below. However, the attachment method described below is merely an example and can be modified as necessary.

Referring to FIG. 8 together with FIG. 3, firstly, the fixable portion 41 of the nut component 40 is placed on the projecting portions 36 so that the screw holes 44 are located right over the upper passing holes 37, respectively. The thus-placed fixable portion 41 is located rearward of the end surface 342 of the flange 34, and the downward extending portion 42 is located rearward of the fixable portion 41. Hereafter, the position of the thus-arranged nut component 40 is referred to as “initial position”, and the state of the thus-arranged nut component 40 is referred to as “initial state”.

Referring to FIG. 8 together with FIGS. 3 and 4, when the nut component 40 is located at the initial position, the lower passing holes 46 of the movable portion 45 are located right under the upper passing holes 37, respectively, and are apart from lower ends of the upper passing holes 37. When the two screws 60 are screwed into the screw holes 44 of the nut component 40, which is located at the initial position, through the lower passing holes 46 and the upper passing holes 37, the nut component 40 is attached to the shell 30 of the connector body 14.

Summarizing the explanation described above, the nut component 40 is configure to be attached to the shell 30 by arranging the fixable portion 41 above the projecting portions 36, arranging the movable portion 45 below the projecting portions 36 and screwing the two screws 60 into the screw holes 44 of the fixable portion 41, respectively, through the lower passing holes 46 of the movable portion 45 and the upper passing holes 37 of the projecting portions 36. However, according to this attachment method, the coaxial connector 12 is not connected to the board 16. The processes described below are necessary in order to connect the coaxial connector 12 to the board 16.

Referring to FIGS. 8 and 9 together with FIGS. 3 and 4, a gap larger than the thickness of the board 16 is formed between the lower ends of the upper passing holes 37 of the projecting portions 36 and the movable portion 45 of the nut component 40 which is located at the initial position. The front end part of the board 16 is inserted into this gap so that the passing holes 72 are located between the upper passing holes 37 and the lower passing holes 46 of the movable portion 45, respectively.

Then, referring to FIGS. 9 and 10 together with FIGS. 3 and 4, the two screws 60 are screwed into the screw holes 44 of the nut component 40, which is located at the initial position, through the lower passing holes 46, the passing holes 72 and the upper passing holes 37, and thereby the nut component 40 is attached to the shell 30 of the connector body 14 together with the board 16. Meanwhile, the heads 62 of the screws 60 are pressed against the movable portion 45. As a result, the front end part of the board 16 is sandwiched and held between lower surfaces of the projecting portions 36 and an upper surface of the movable portion 45, and the fixable portion 41 is pressed against upper surfaces of the projecting portions 36.

Summarizing the explanation described above, the nut component 40 is configured to be attached to the shell 30 by arranging the fixable portion 41 above the projecting portions 36, arranging the movable portion 45 below the projecting portions 36, inserting the board 16 between the projecting portions 36 and the movable portion 45 and screwing the two screws 60 into the screw holes 44 of the fixable portion 41, respectively, through the lower passing holes 46 of the movable portion 45, the passing holes 72 of the board 16 and the upper passing holes 37 of the projecting portions 36. When the nut component 40 is attached to the shell 30 together with the board 16, the coaxial connector 12 takes the connected state where it is connected to the board 16.

Referring to FIG. 12, according to the coaxial connector 12 of the present embodiment, the fixable portion 41 pressed against the projecting portions 36 of the shell 30 is fixed and connected to the shell 30. Thus, the nut component 40 attached to the shell 30 is electrically connected with the shell 30 through the fixable portion 41.

Referring to FIGS. 7 and 12, in each of the coupling portions 47 of the nut component 40, the lower connection portion 49 is located forward of the upper connection portion 48. Each of the screw holes 44 of the nut component 40 has a center 442, or an imaginary center axis, which is located forward of the upper connection portion 48 of the corresponding coupling portion 47. In detail, in each of the coupling portions 47, the middle point of the lower connection portion 49 in the front-rear direction is located forward of the middle point of the upper connection portion 48 in the front-rear direction. The center 442 of each of the screw holes 44 is located forward of the middle point of the upper connection portion 48 of the corresponding coupling portion 47 in the front-rear direction.

Referring to FIGS. 7 and 12 together with FIG. 14, according to the aforementioned positional relation, when the nut component 40 is attached to the shell 30 together with the board 16 by using the screws 60, each of the coupling portions 47 is resiliently deformed, and thereby the movable portion 45 is moved upward and forward. As previously described, the movable portion 45 of the present embodiment is not divided into two parts in the lateral direction. This structure reduces a movement of the movable portion 45 in the lateral direction so that the movable portion 45 is easily moved forward. Referring to FIGS. 12 and 13, the movable portion 45, which is moved upward, is pressed against the ground layer 76 of the board 16. As a result, the connector assembly 10 is formed with a first ground path which extends between the projecting portions 36 and the ground layer 76 through the fixable portion 41, the coupling portions 47 and the movable portion 45 of the nut component 40. The shell 30 is grounded to the ground layer 76 via the first ground path.

When the nut component 40 is located at the initial position, the front end of the movable portion 45 thereof can be arranged in the vicinity of the end surface 342 of the flange 34 of the shell 30. The thus-arranged movable portion 45 can be pressed against the flange 34 when moved forward. As a result, the connector assembly 10 is formed with a second ground path which extends between the flange 34 and the ground layer 76 through only the movable portion 45 of the nut component 40. The shell 30 can be grounded to the ground layer 76 via the second ground path, which is the shortest ground path, in addition to the first ground path. In addition, by using the screws 60 each made of metal, the connector assembly 10 is formed with a third ground path which extends between the projecting portions 36 and the ground layer 76 through the fixable portion 41, the screws 60 and the movable portion 45. The shell 30 can be also grounded to the ground layer 76 via the third ground path.

As described above, the shell 30 of the present embodiment can be reliably grounded to the ground layer 76 of the board 16 via the nut component 40. Thus, the present embodiment provides the coaxial connector 12 which comprises the shell 30 configured to be stably connected to the ground layer 76 of the board 16.

Hereafter, further specific explanation will be made about the structure of the coaxial connector 12 (see FIG. 11) of the present embodiment.

Referring to FIG. 8, if the downward extending portion 42 is not provided, the nut component 40 might be placed on the projecting portions 36 in a reversed state where the front end of the nut component 40 illustrated in FIG. 8 faces rearward. If the nut component 40 is placed as described above, the movable portion 45 is moved rearward when the screws 60 are screwed. According to the present embodiment, because the downward extending portion 42 is provided, the nut component 40 is prevented from being arranged on the projecting portions 36 in the reversed state. In addition, the board 16 can be prevented from being inserted between the fixable portion 41 and the upper surfaces of the projecting portions 36. However, the present invention is not limited thereto. For example, some part other than the downward extending portion 42 may work similarly to the downward extending portion 42.

Referring to FIGS. 12 and 13, each of the regulation portions 39 is located rearward of a part of the nut component 40 other than the movable portion 45 and is configured to regulate a rearward movement of the fixable portion 41. More specifically, each of the regulation portions 39 of the present embodiment is located rearward of an upper end part of the coupling portion 47. When the fixable portion 41 is moved rearward during a process in which the screws 60 are screwed into the screw holes 44 of the fixable portion 41, respectively, the upper end parts of the coupling portions 47 are brought into abutment with the regulation portions 39, respectively, and thereby the fixable portion 41 is stopped. The movable portion 45 is moved forward relative to the fixable portion 41 which is substantially unmovable. Thus, the movable portion 45 is reliably moved toward the flange 34.

The regulation portions 39 of the present embodiment are arranged as described above and work as described above. However, the present invention is not limited thereto. Referring to FIG. 10, in an instance in which the fixable portion 41 is not provided with the downward extending portion 42, the regulation portions 39 may be located rearward of the fixable portion 41. In this instance, the regulation portions 39 may project upward from rear ends of the upper surfaces of the projecting portions 36. Referring to FIG. 12, in an instance in which the upper passing holes 37 of the projecting portions 36 are formed with female threads for screwing the screws 60, the fixable portion 41 is not moved when the screws 60 are screwed into the screw holes 44 of the fixable portion 41, respectively. In this instance, the regulation portions 39 do not need to be provided.

Referring to FIG. 7, as described above, the nut component 40 under the initial state meets a first connection condition that ″in each of the coupling portions 47, the lower connection portion 49 is located forward of the upper connection portion 48″ and a second connection condition that ″the center 442 of each of the screw holes 44 is located forward of the upper connection portion 48 of the corresponding coupling portion 47″. However, the present invention is not limited thereto.

For example, the upper connection portion 48 of each of the coupling portions 47 of the nut component 40 has a first size SZ1 in the front-rear direction. In each of the coupling portions 47, the middle point of the upper connection portion 48 in the front-rear direction is apart from the middle point of the lower connection portion 49 in the front-rear direction by a second size SZ2 in the front-rear direction. The nut component 40 meets a third connection condition that ″in each of the coupling portions 47, the second size SZ2 is equal to or more than the first size SZ1″ in addition to the first and second connection conditions under the initial state. According to this third connection condition, the movable portion 45 is easily moved forward.

In the nut component 40, each of the coupling portions 47 has a middle portion which is located between the upper connection portion 48 and the lower connection portion 49 and extends along a predetermined direction P intersecting with both the front-rear direction and the up-down direction. Each of the middle portions has a third size SZ3 in a direction perpendicular to the predetermined direction P. The nut component 40 under the initial state meets a fourth connection condition that ″in each of the coupling portions 47, the first size SZ1 is equal to or more than the third size SZ3″ in addition to the first to third connection conditions. According to the fourth connection condition, each of the coupling portions 47 is resiliently deformable easily, and thereby the movable portion 45 is reliably movable forward.

The nut component 40 of the present embodiment meets all of the first to fourth connection conditions. However, the present invention is not limited thereto. The nut component 40 may meet none of the third connection condition and the fourth connection condition or may meet only one of the third connection condition and the fourth connection condition, provided that the nut component 40 meets the first connection condition and the second connection condition.

Referring to FIG. 11 together with FIG. 12, the signal line 74 of the board 16 is pushed from below by the movable portion 45 of the nut component 40 under the connected state. The thus-pushed signal line 74 is pressed against and is brought into contact with the contact portion 22 of the contact 20. Thus, the contact portion 22 and the signal line 74 are electrically connected with each other without soldering. However, the present invention is not limited thereto. For example, the contact portion 22 and the signal line 74 may be connected to each other via soldering.

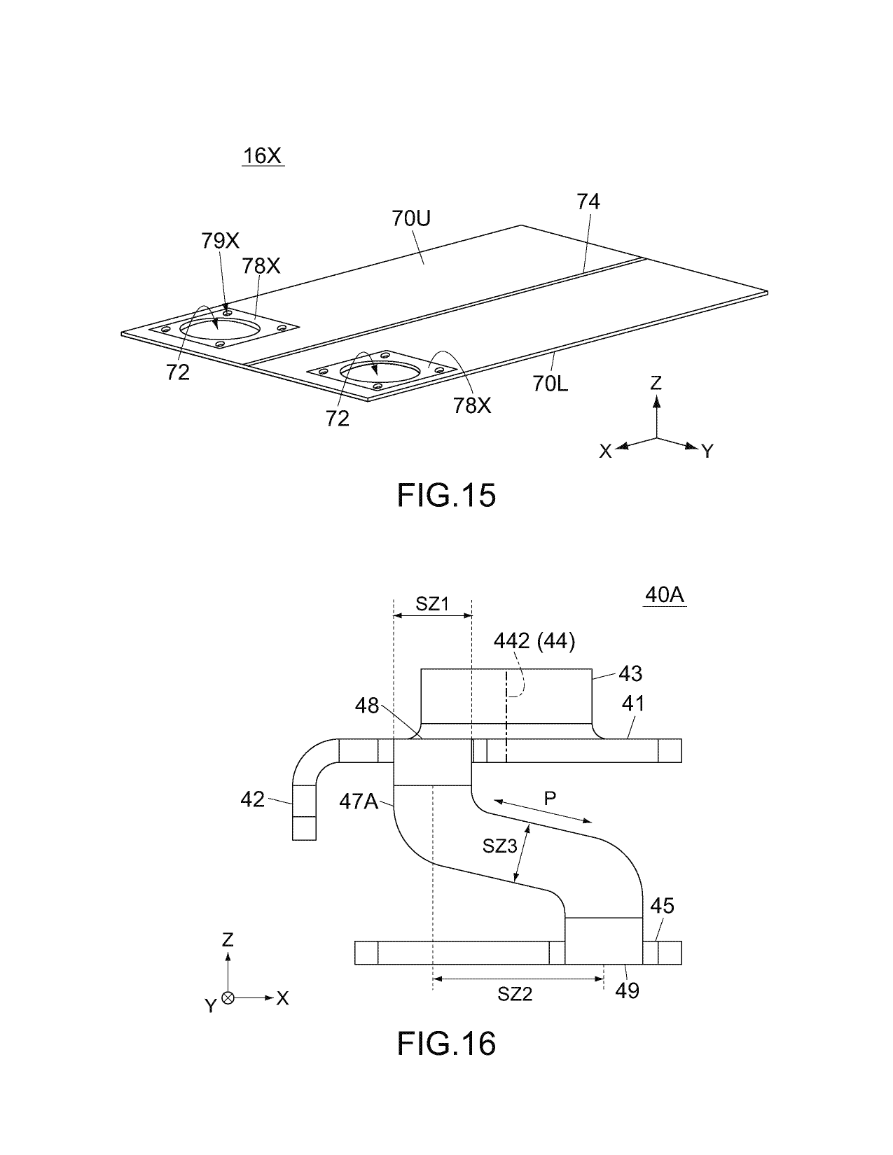

Referring to FIG. 15 together with FIG. 1, the coaxial connector 12 may be connected to a board 16X according to a modification instead of the board 16. The upper surface 70U of the board 16X is formed with two ground patterns 78X which are not provided on the board 16. Referring to FIG. 15 together with FIG. 13, each of the ground patterns 78X is connected with the ground layer 76 through a plurality of via holes 79X. Referring to FIG. 15 together with FIG. 11, the ground patterns 78X are formed at positions which correspond to the two projecting portions 36 of the coaxial connector 12, respectively. Under the connected state, the projecting portions 36 are pressed against the ground patterns 78X, respectively, and thereby the shell 30 is grounded to the ground layer 76 via the projecting portions 36 and the ground patterns 78X in addition to the previously described various ground paths.

Referring to FIG. 15, the illustrated ground patterns 78X are provided only on a front end part of the board 16X. However, the present invention is not limited thereto. The ground patterns 78X may extend to a rear end part of the board 16X in parallel to the signal line 74 with the signal line 74 located therebetween in the lateral direction. Thus, the board 16X may be formed with a so-called coplanar line.

The nut component 40 (see Fig.4) of the present embodiment can be further variously modified as described below in addition to the already described various modifications.

Referring to FIG. 13 together with FIG. 11, the middle of the movable portion 45 of the nut component 40 in the lateral direction may be formed with a projection which projects forward. The thus-formed projection is located right under the signal line 74 with the board 16 located therebetween under the connected state and is securely pressed against the end surface 342 of the flange 34. According to this structure, the electric connection between the shell 30 and the ground layer 76 can be made further secure.

Comparing FIG. 16 with FIG. 7, a nut component 40A according to a first modification has coupling portions 47A different from the coupling portions 47 of the nut component 40. The second size SZ2 of the nut component 40A is larger than the second size SZ2 of the nut component 40. The nut component 40A has a structure similar to that of the nut component 40 except for the aforementioned differences and meets the first to fourth connection conditions. Thus, the nut component 40A works similarly to the nut component 40.

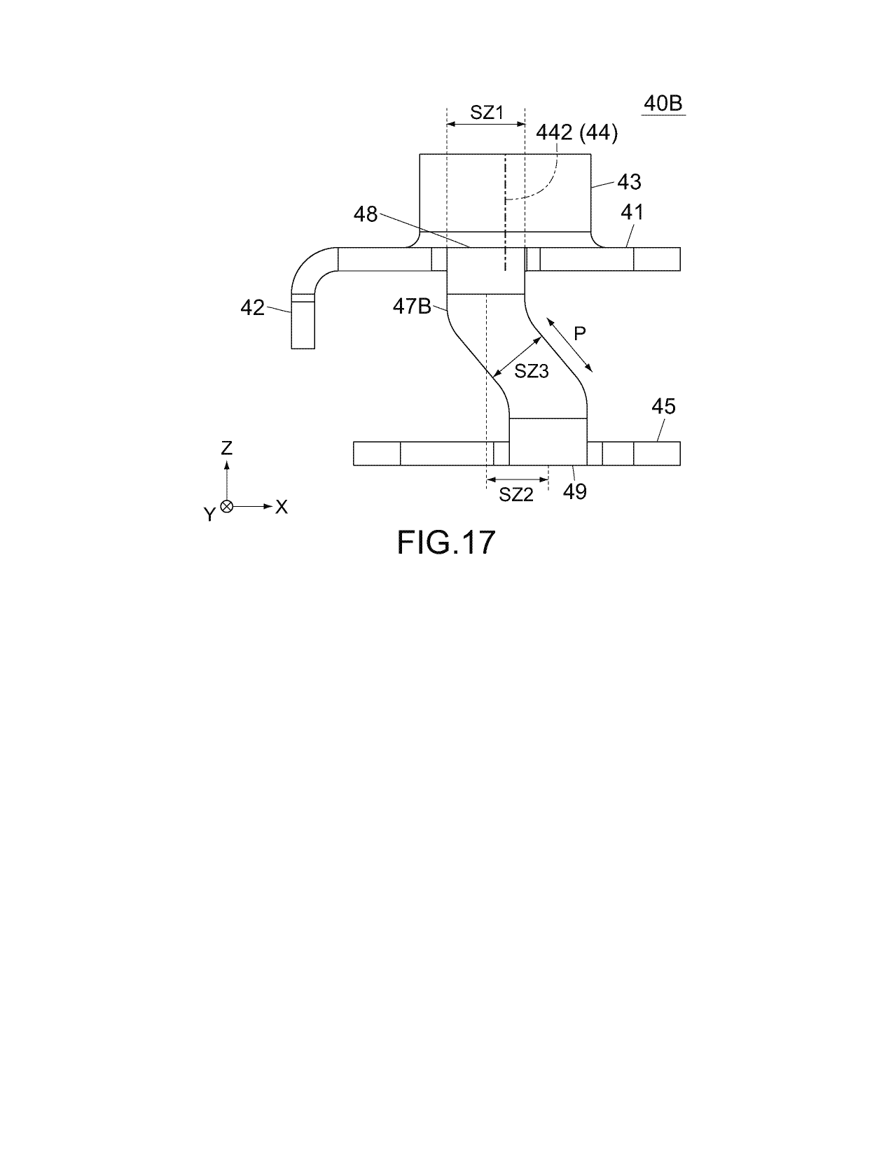

Comparing FIG. 17 with FIG. 7, a nut component 40B according to a second modification has coupling portions 47B different from the coupling portions 47 of the nut component 40. The second size SZ2 of the nut component 40B is smaller than the second size SZ2 of the nut component 40. The nut component 40B has a structure similar to that of the nut component 40 except for the aforementioned differences and meets the first to fourth connection conditions. Thus, the nut component 40B works similarly to the nut component 40.

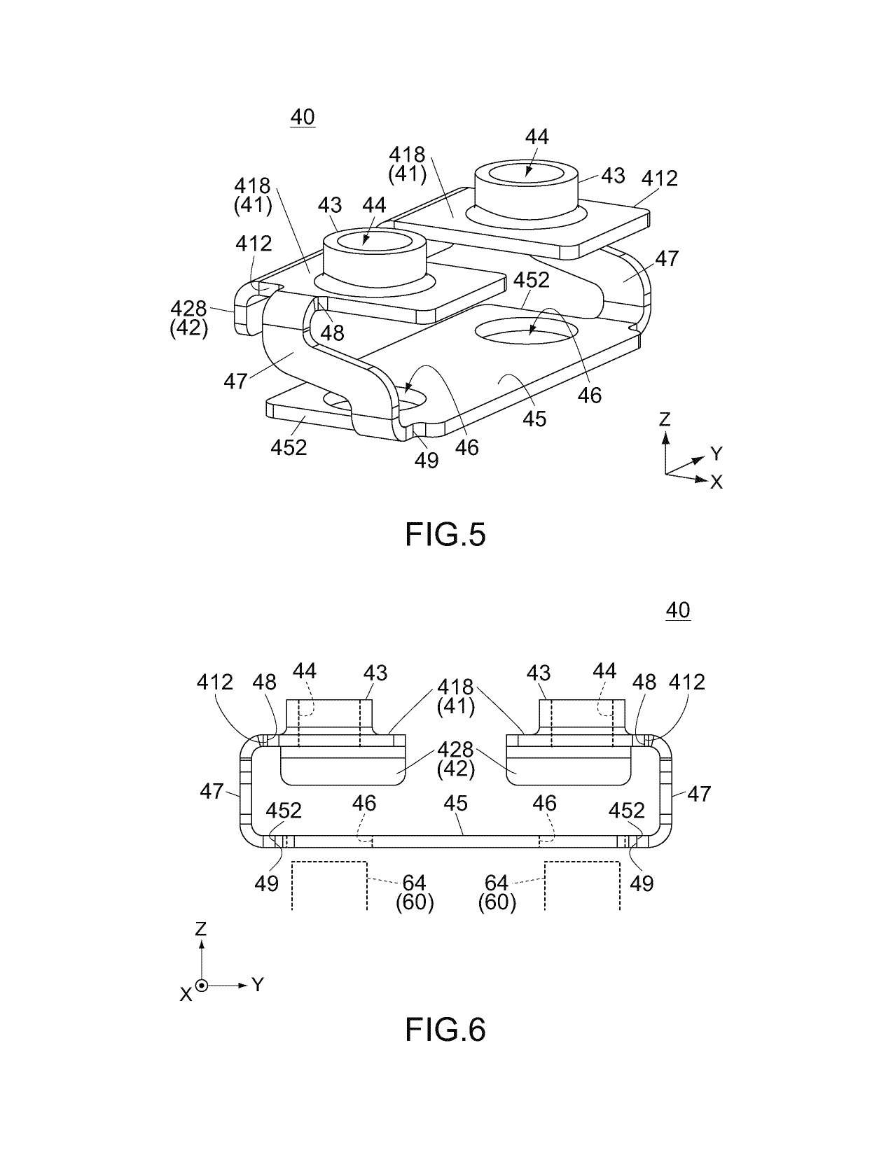

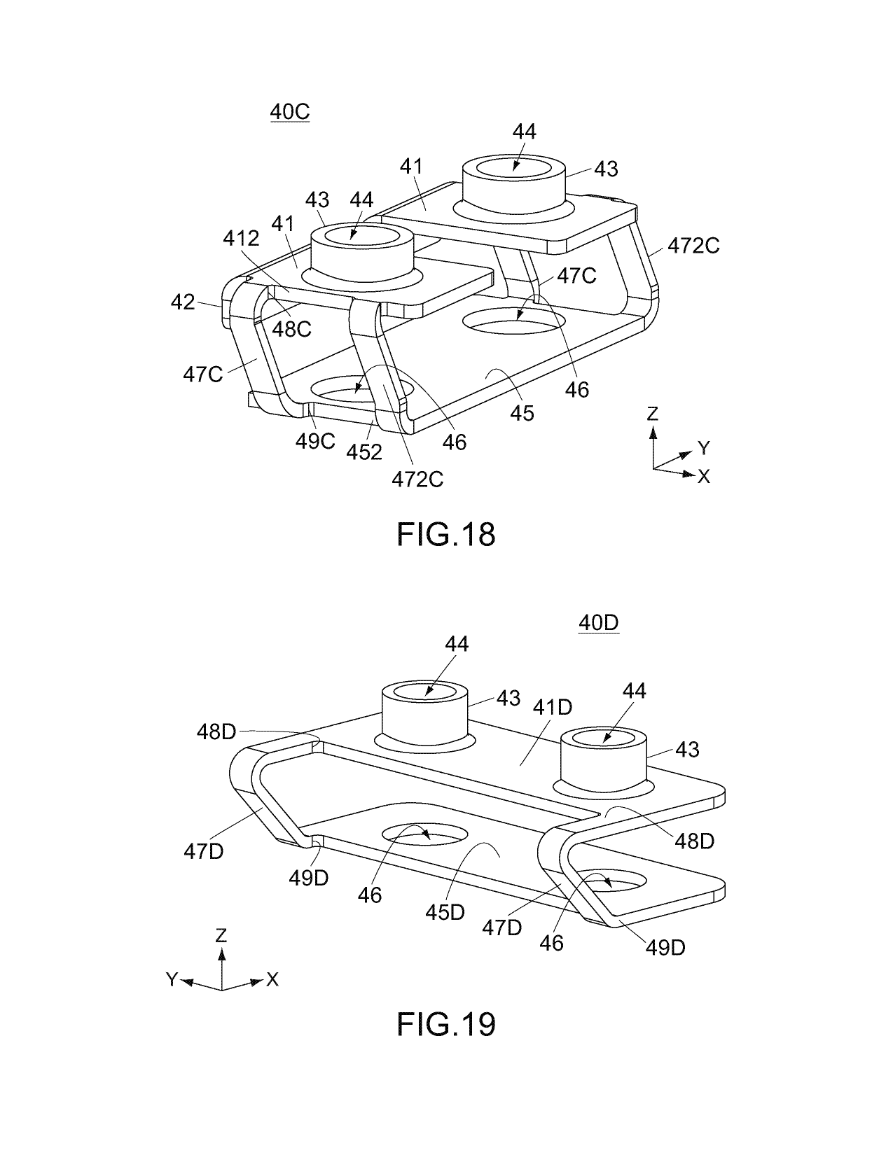

Comparing FIG. 18 with FIG. 5, a nut component 40C according to a third modification has two additional coupling portions 472C which are not provided on the nut component 40 in addition to coupling portions 47C similar to the coupling portions 47 of the nut component 40. Each of the coupling portions 47C has an upper connection portion 48C which is located at a boundary between the coupling portion 47C and the fixable portion 41 and a lower connection portion 49C which is located at a boundary between the coupling portion 47C and the movable portion 45. Each of the coupling portions 47C extends between the upper connection portion 48C and the lower connection portion 49C without meandering. Each of the additional coupling portions 472C has a structure similar to that of the coupling portion 47C. The additional coupling portions 472C are located forward of the two coupling portions 47C, respectively. The nut component 40C has a structure similar to that of the nut component 40 except for the aforementioned differences and meets the first and second connection conditions. Thus, the nut component 40C works similarly to the nut component 40.

Comparing FIG. 19 with FIG. 4, a nut component 40D according to a fourth modification has a fixable portion 41D, a movable portion 45D and two coupling portions 47D which are different from the fixable portion 41, the movable portion 45 and the coupling portions 47 of the nut component 40, respectively. Each of the coupling portions 47D has an upper connection portion 48D which is located at a boundary between the coupling portion 47D and the fixable portion 41D and a lower connection portion 49D which is located at a boundary between the coupling portion 47D and the movable portion 45D. Each of the upper connection portions 48D is located on a rear edge of the fixable portion 41D. Each of the lower connection portions 49D is located on a rear edge of the movable portion 45D. Each of the coupling portions 47D extends rearward from the upper connection portion 48D and then extends substantially straight to the lower connection portion 49D.

The nut component 40D has a structure similar to that of the nut component 40 except for the aforementioned differences and meets the first and second connection conditions. Thus, the nut component 40D works similarly to the nut component 40. Moreover, according to the present modification, the fixable portion 41D can be shaped in a single part which continuously extends with no gap in the lateral direction while the nut component 40D is formed of a single metal plate. Moreover, the present modification can be further modified. For example, the nut component 40D may be formed of a single metal plate while the movable portion 45D instead of the fixable portion 41D is divided into two parts in the lateral direction.

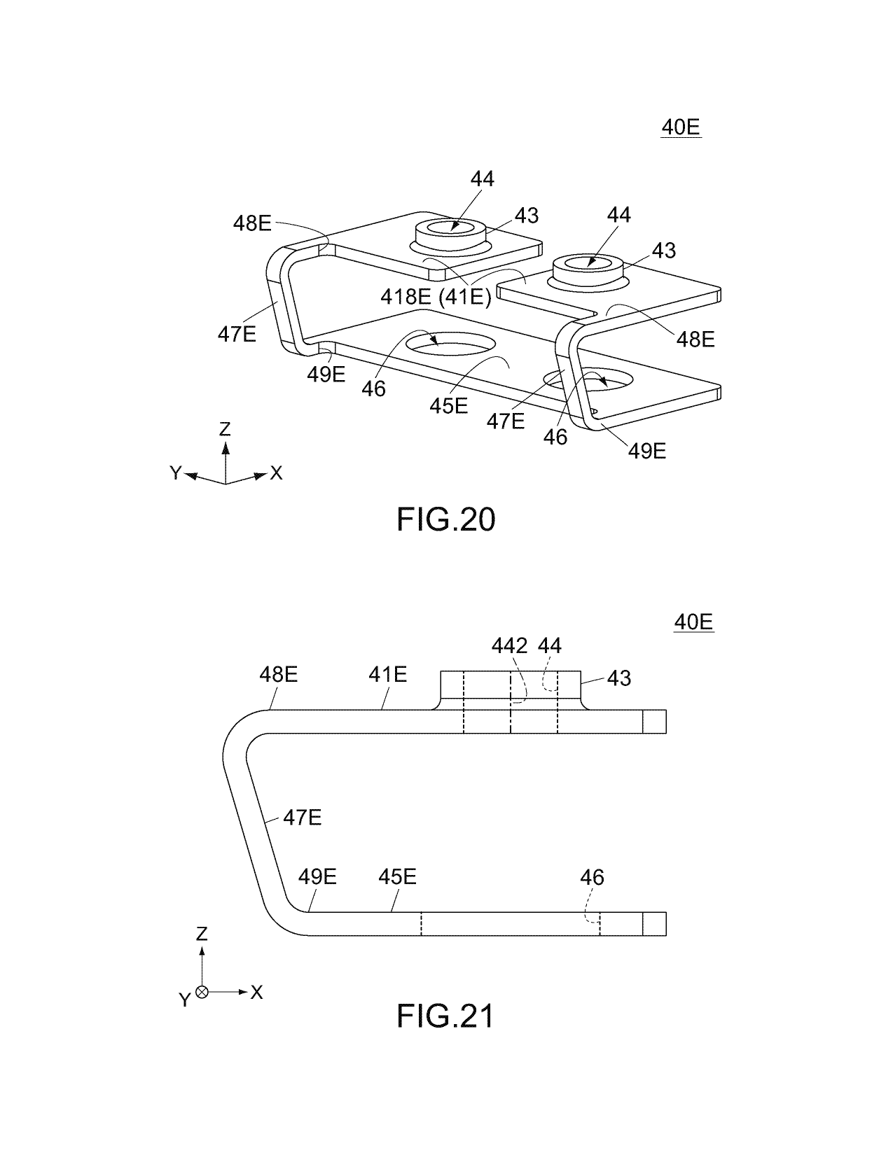

Comparing FIGS. 20 and 21 with FIG. 19, a nut component 40E according to a fifth modification has a fixable portion 41E, a movable portion 45E and two coupling portions 47E which are different from the fixable portion 41D, the movable portion 45D and the coupling portions 47D of the nut component 40D, respectively. The fixable portion 41E is divided into two fixable sections 418E in the lateral direction. Each of the coupling portions 47E has an upper connection portion 48E which is located at a boundary between the coupling portion 47E and the fixable portion 41E and a lower connection portion 49E which is located at a boundary between the coupling portion 47E and the movable portion 45E. The upper connection portions 48E are located on rear edges of the two fixable sections 418E, respectively. Each of the lower connection portions 49E is located on a rear edge of the movable portion 45E. The nut component 40E has a structure similar to that of the nut component 40D except for the aforementioned differences and meets the first and second connection conditions. Thus, the nut component 40E works similarly to the nut component 40D.

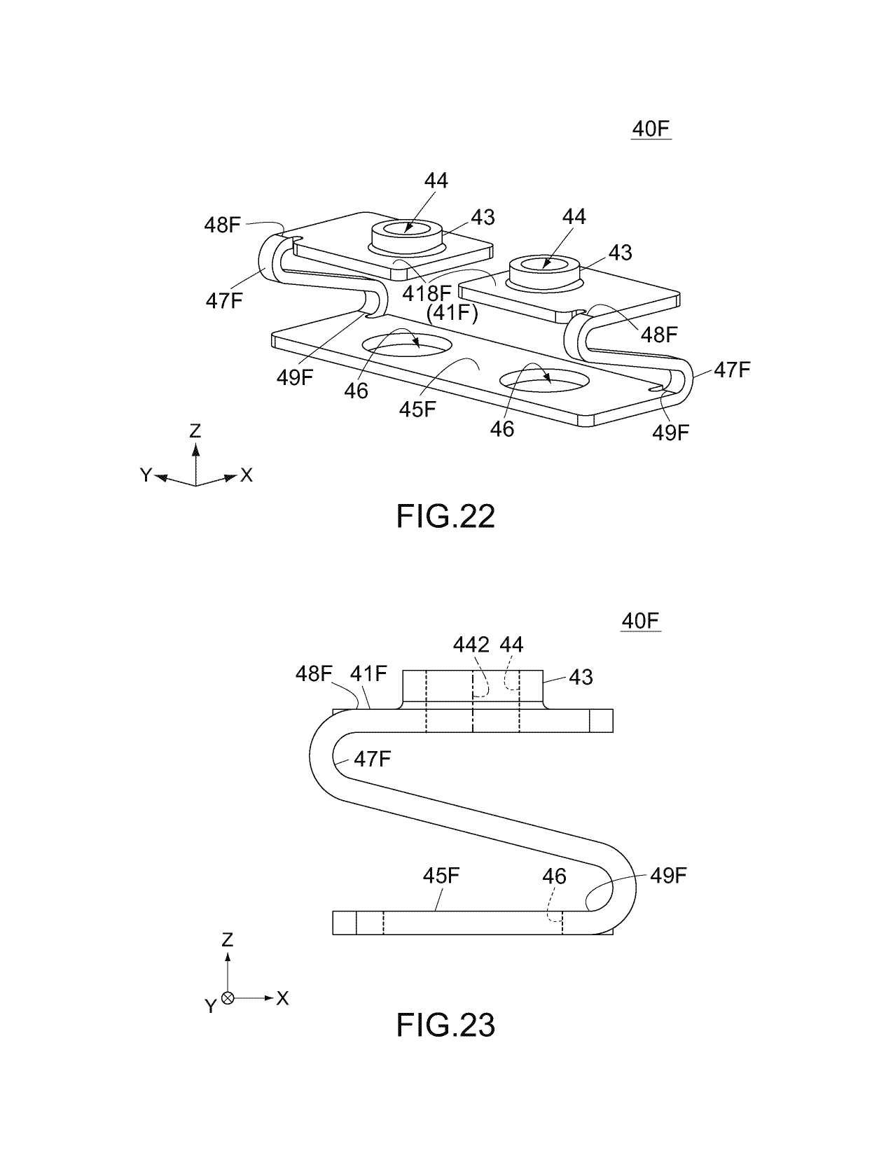

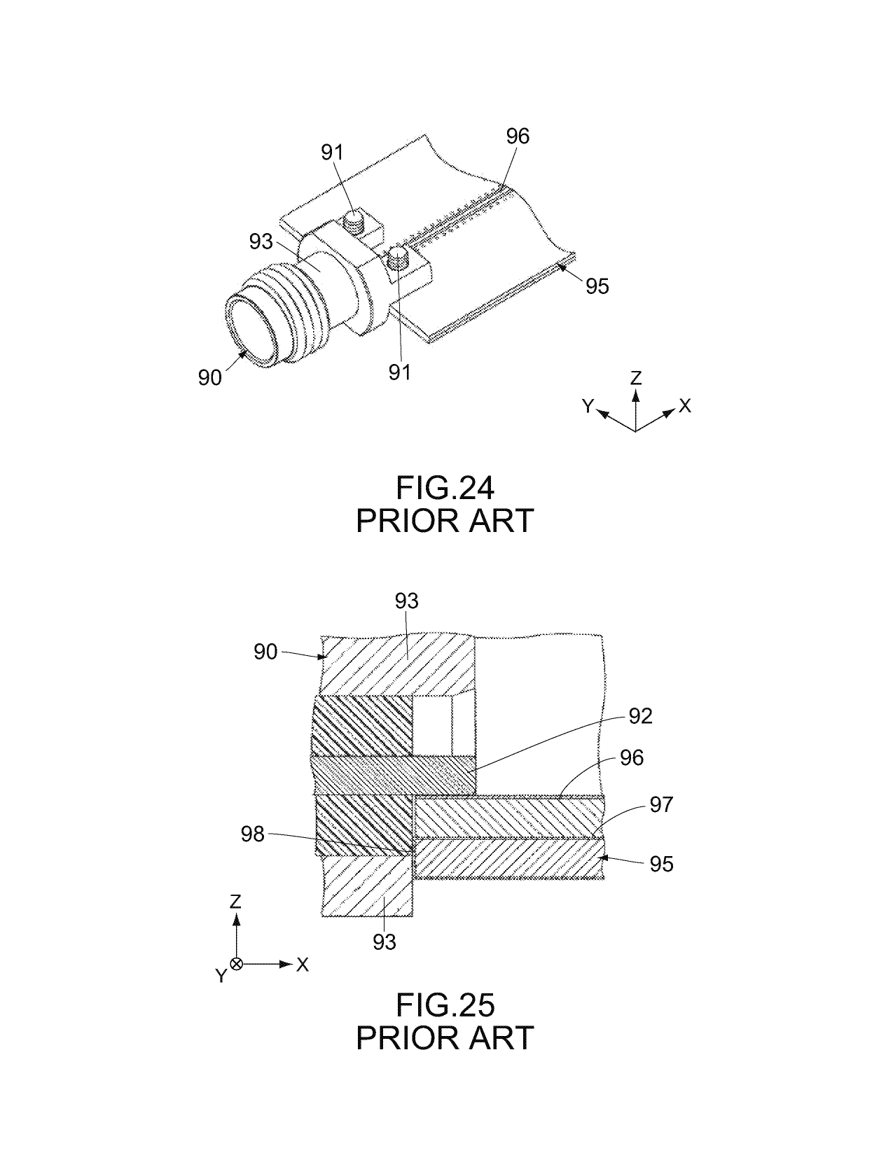

Comparing FIGS. 22 and 23 with FIGS. 20 and 21, a nut component 40F according to a sixth modification has a fixable portion 41F, a movable portion 45F and two coupling portions 47F which are different from the fixable portion 41E, the movable portion 45E and the coupling portions 47E of the nut component 40E, respectively. The fixable portion 41F is divided into two fixable sections 418F in the lateral direction. Each of the coupling portions 47F has an upper connection portion 48F which is located at a boundary between the coupling portion 47F and the fixable portion 41F and a lower connection portion 49F which is located at a boundary between the coupling portion 47F and the movable portion 45F. The upper connection portions 48F are located on rear edges of the two fixable sections 418F, respectively. Each of the lower connection portions 49F is located on a front edge of the movable portion 45F. The nut component 40F has a structure similar to that of the nut component 40E except for the aforementioned differences and meets the first and second connection conditions. Thus, the nut component 40F works similarly to the nut component 40E.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A coaxial connector which is configured to be attached to a rear end of a coaxial cable in a front-rear direction and is configured to be connected to a board, the board having an upper surface and a lower surface in an up-down direction perpendicular to the front-rear direction and being formed with two passing holes each passing through the board in the up-down direction, the upper surface of the board being formed with a signal line, the signal line being located between the two passing holes in a lateral direction perpendicular to both the front-rear direction and the up-down direction, the lower surface of the board being formed with a ground layer, wherein:
the coaxial connector comprises a shell, a contact, a nut component made of metal and two screws;
the shell has a flange and two projecting portions;
each of the projecting portions projects rearward from the flange;
each of the projecting portions is formed with an upper passing hole;
each of the upper passing holes passes through the projecting portion in the up-down direction;
the nut component has a fixable portion, a movable portion and two coupling portions;
the fixable portion is located at an upper side of the nut component;
the movable portion is located at a lower side of the nut component;
each of the coupling portions couples the fixable portion and the movable portion together;
the fixable portion is formed with two screw holes which correspond to the coupling portions, respectively;
the movable portion is formed with two lower passing holes;
each of the lower passing holes passes through the movable portion in the up-down direction;
the nut component is configured to be attached to the shell by arranging the fixable portion above the projecting portions, arranging the movable portion below the projecting portions, inserting the board between the projecting portions and the movable portion and screwing the two screws into the screw holes of the fixable portion, respectively, through the lower passing holes of the movable portion, the passing holes of the board and the upper passing holes of the projecting portions;
each of the coupling portions of the nut component has an upper connection portion and a lower connection portion;
each of the upper connection portions is located at a boundary between the coupling portion and the fixable portion;
each of the lower connection portions is located at a boundary between the coupling portion and the movable portion;
in each of the coupling portions, the lower connection portion is located forward of the upper connection portion; and
each of the screw holes has a center which is located forward of the upper connection portion of a corresponding one of the coupling portions.

2. The coaxial connector as recited in claim 1, wherein:
the fixable portion has two upper edges;
each of the upper edges is located at an outer edge of the fixable portion in the lateral direction;
the movable portion has two lower edges;
each of the lower edges is located at an outer edge of the movable portion in the lateral direction;
each of the coupling portions couples one of the upper edges and one of the lower edges together; and
the movable portion is a single plate formed with the two lower passing holes.

3. The coaxial connector as recited in claim 1, wherein:
the nut component has a downward extending portion; and
the downward extending portion extends downward from a rear end of the fixable portion.

4. The coaxial connector as recited in claim 1, wherein:
the shell is provided with a regulation portion; and
the regulation portion is located rearward of a part of the nut component other than the movable portion and is configured to regulate a rearward movement of the fixable portion.

5. The coaxial connector as recited in claim 1, wherein:
the upper connection portion of each of the coupling portions has a first size in the front-rear direction;
in each of the coupling portions, a middle point of the upper connection portion in the front-rear direction is apart from a middle point of the lower connection portion by a second size in the front-rear direction; and
in each of the coupling portions, the second size is equal to or more than the first size.

6. The coaxial connector as recited in claim 1, wherein:
the upper connection portion of each of the coupling portions has a first size in the front-rear direction;
each of the coupling portions has a middle portion which is located between the upper connection portion and the lower connection portion and extends along a predetermined direction intersecting with both the front-rear direction and the up-down direction;
each of the middle portions has a third size in a direction perpendicular to the predetermined direction; and
in each of the coupling portions, the first size is equal to or more than the third size.
